(19) United States
(12) Patent Application Publication
(10) Pub. No.: US 2010/0243846 A1
(43) Pub. Date: Sep. 30, 2010

(54) CONNECTION BASE DEVICE FOR CONNECTING VARIOUS OBJECTS

(76) Inventor: Eagle Fan, Hsinchu (TW)

Correspondence Address: RABIN & Berdo, PC, 1101 14TH STREET, NW, SUITE 500, WASHINGTON, DC, 20005, US

(21) Appl. No.: 12/414,907

(22) Filed: Mar. 31, 2009

(51) Int. Cl. F16M 13/00

(52) U.S. Cl. 248/346.03

(57) ABSTRACT

A connection base device for connecting to various objects is provided, including at least a heavy unit, a fix unit and a connection unit. The fix unit is engaged to the bottom of the connection unit. The fix unit and the connection unit clap a part of area of the heavy unit and hold to fasten together. The top surface of the connection unit includes a smooth suction area. At the center region of the suction area is an engaging trench for providing engagement to other objects directly. The wall and the bottom of the engaging trench are completely sealed so that when the engaging trench is not in use, an object with a suction disc can be attached to the suction area by suction disc.

### FIELD OF THE INVENTION

The present invention generally relates to a connection base device, and more particularly to a connection base device for providing connection to a wide range of various objects.

### BACKGROUND OF THE INVENTION

The connection base device of the present invention refers to a platform providing connection to other objects. The connection base device is of considerable weight, and can be placed on the flat surface of the dashboard of a vehicle or other locations. The connection base device will not shift or move when the vehicle is traveling so that the electronic apparatuses can be anchored to the connection base device. The connection base device has the advantage of not damaging the interior decoration of the vehicle. The related patent is such as U.S. patent application Ser. No. 12/115,647.

When an electronic apparatus, such as, GPS, PDA or video player, needs to be installed to the connection base device, a support clapper set is usually used. The support clapper set is usually directly engaged and fixed to the connection base device. Therefore, the connection base device must include matching buckle structure or lock/latch structure. The conventional connection base device usually provides a single type of structure to match a single type of support clapper set. To use a different type of support clapper set, a different type of connection base device must be used. This limitation is both wasteful and inconvenient. It is imperative to devise a connection device that is able to provide connection to different types of objects.

### SUMMARY OF THE INVENTION

The primary object of the present invention is to provide a connection base device for connecting various objects. In addition to engaging the objects by direct screwing, buckling or latching, the present invention also provide attachment for suction disc. In this manner, a wide range of electronic apparatuses can be connected by other objects to the connection base device of the present invention.

Another object of the present invention is to provide a convenient and inexpensive connection base device.

The connection base device of the present invention provides connection so that electronic apparatuses can use other objects to connect to the connection base device. The connection base device includes at least a connection unit. The top surface of the connection unit includes a smooth suction area. At the center region of the suction area includes an engaging trench for providing connections to other objects. The wall and the bottom of the engaging trench are completely sealed except the opening to the suction area. When the engaging trench is not in use, the object with a suction disc can be attached to the suction area by suction disc.

To achieve the above objects, the present invention provides a connection base device, including at least a heavy unit, a fix unit and a connection unit. The heavy unit includes a wrapping element, an anti-slip element and at least a heavy element. The majority of the edges of anti-slip element and wrapping element are engaged together. The heavy element is located inside the space formed between the anti-slip element and the wrapping element. The fix unit is engaged to the bottom of the connection unit. The fix unit and the connection unit clap a part of area of the heavy unit and hold to fasten together. The top surface of the connection unit includes a smooth suction area. At the center region of the suction area is an engaging trench for providing engagement to other objects directly. The wall and the bottom of the engaging trench are completely sealed so that when the engaging trench is not in use, an object with a suction disc can be attached to the suction area by suction disc.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a a schematic view of the present invention;

FIG. 2 shows a cross-sectional view of the present invention;

FIG. 3 shows a schematic view of the present invention in an actual application;

FIG. 4 shows a schematic view of the present invention in another actual application; and

FIG. 5 shows a schematic view of another embodiment of the present invention.

### DETAILED DESCRIPTION OF THE PREFERRED EMBODIMENTS

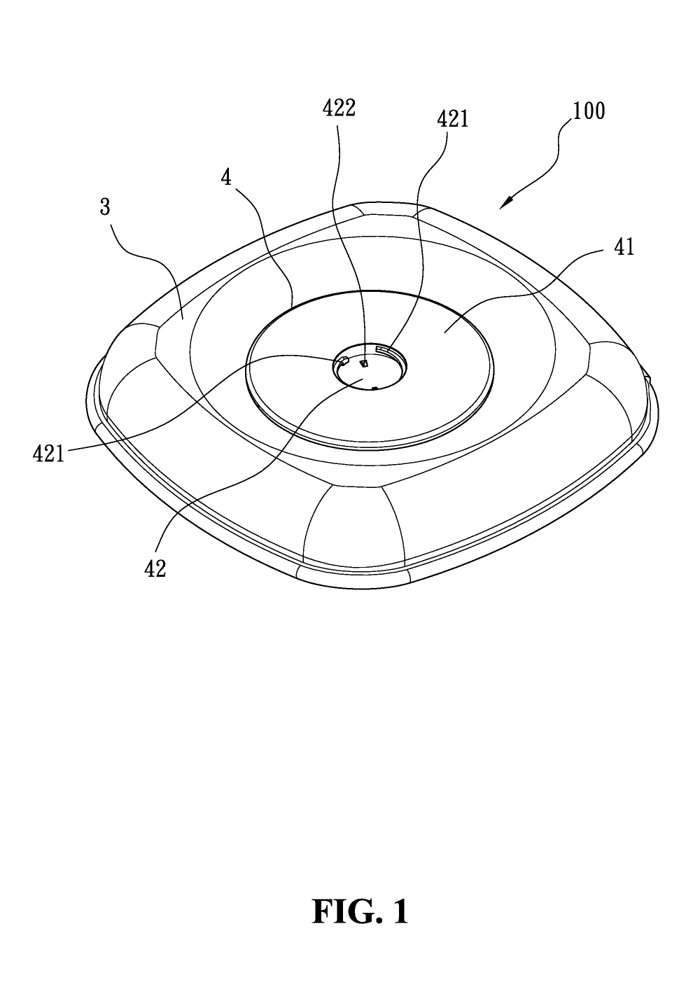

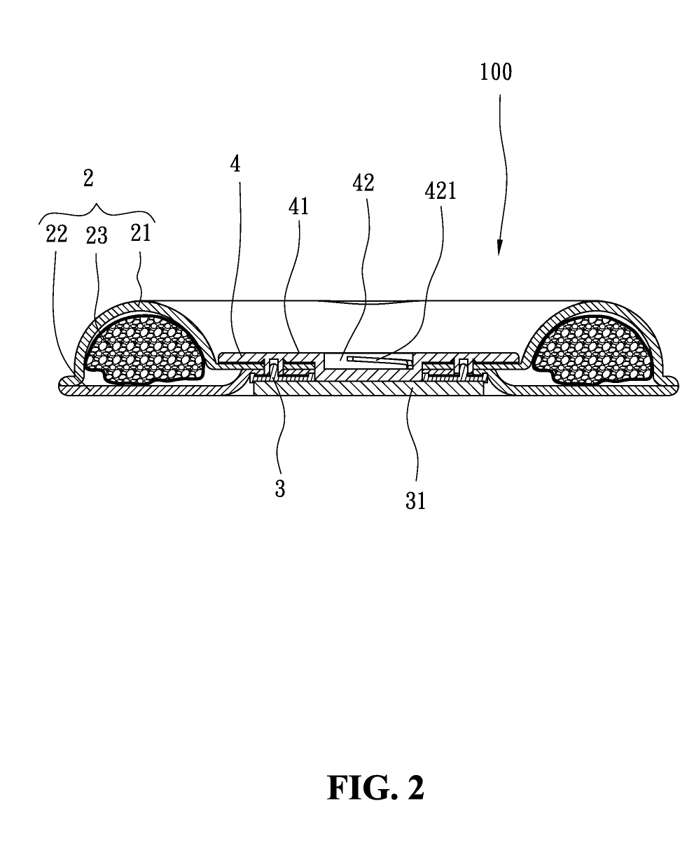

FIG. 1 and FIG. 2 shows a schematic view and a cross-sectional view of the connection base device according to the present invention. Connection base device 100 includes at least a heavy unit 2, a fix unit 3 and a connection unit 4. Heavy unit 2 includes a wrapping element 21, an anti-slip element 22, and at least a heavy element 23. Wrapping element 21 is located at the upper part of heavy unit 2 and anti-slip element 22 is at the bottom part of heavy unit 2. The majority of edges of wrapping element 21 and anti-slip element 22 are engaged together. Heavy element 23 is placed inside the space formed between anti-slip element 22 and wrapping element 21. The number of heavy element 23 in this embodiment is 1. The center region is not sealed. The skirt edge close to the center region of heavy unit 2 is clapped by connection unit 4 and fix unit 3 so that the units are held tightly together. The clapping and engagement between connection unit 4 and fix unit 3 are not limited to any specific type, such as, glue, rivet, screw, and so on. In the present embodiment, fix unit 3 is a ring-shaped disc with a size smaller than the size of connection unit 4. Furthermore, the bottom of fix unit 3 can be further glued to an anti-slip cloth to enhance the anti-slip effect of connection base device 100.

The main improved feature of the present invention is the special structure formed at the top surface of connection unit 4. As shown in FIG. 1, the top surface of connection unit 4 forms a suction area 41 and an engaging trench 42. Suction area 41 is a smooth surface able to provide attachment for suction disc. Engaging trench 42 is a concave space located at the center region of suction area 41. The wall and the bottom of engaging trench 42 are completely sealed except the opening to suction area 41. Therefore, there is no gap for air leakage. In other words, engaging trench 42 will not affect the suction effect to suction area 41. The shape of engaging trench 42 must match the object to be engaged to. In the present embodiment, the wall of engaging trench forms a pair of opposite guiding tracks 421. Guiding tracks 421 are spiral-shaped. The bottom of engaging trench includes a positioning protruding block 422. The structure must match the object to be connected to in the present embodiment.

Connection unit 4 of the present invention uses engaging trench 42 to provide connection to other objects by direct screwing for engagement. When engaging trench 42 is not in use, suction area 41 provides connection to object with suction disc by suction disc for attachment. In this manner, at least two different types of objects can be connected to connection base device 100.

In the present embodiment, connection unit 4 is round. But the shape of connection unit 4 is not limited to any specific shape. For example, connection unit can be oval, rectangular, square or even other irregular shape. In addition, the shape and the size of suction area 41 of the present embodiment resemble those of connection unit 4. However, the shape and the size of suction area 41 are not limited to any specific design. Suction area 41 can also form on a part of area on the top surface of connection unit 4. The shape and size of suction area 41 can also be different from those of connection unit 4. The only restriction of suction area 41 is that it must be larger than the suction disc to be attached to.

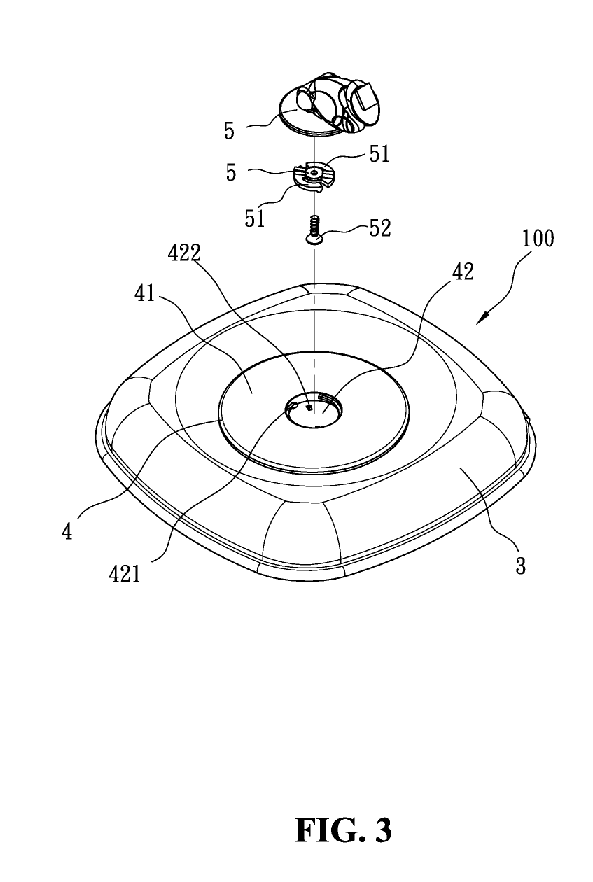

FIG. 3 shows a schematic view of the present invention in actual application. Adjustable support set 5 of FIG. 3 is a multi-joint linkage structure for multi-dimensional adjustment. Support set 5 further includes a buckle element 51. Buckle element 51 is fastened to the bottom of support set 5 by screw 52. Buckle element 51 includes opposite resilient latch blocks 511. When assembled, support set 5 is placed downward to insert buckle element 51 into engaging trench 42, followed by a small angle rotation using guiding tracks 421 of engaging trench 42 so that position protruding blocks 422 and resilient latch blocks 511 will fasten support set 5 to connection unit 4. Then, adjustable support set 5 can further engage a clapper (not shown) to hold any electronic apparatus.

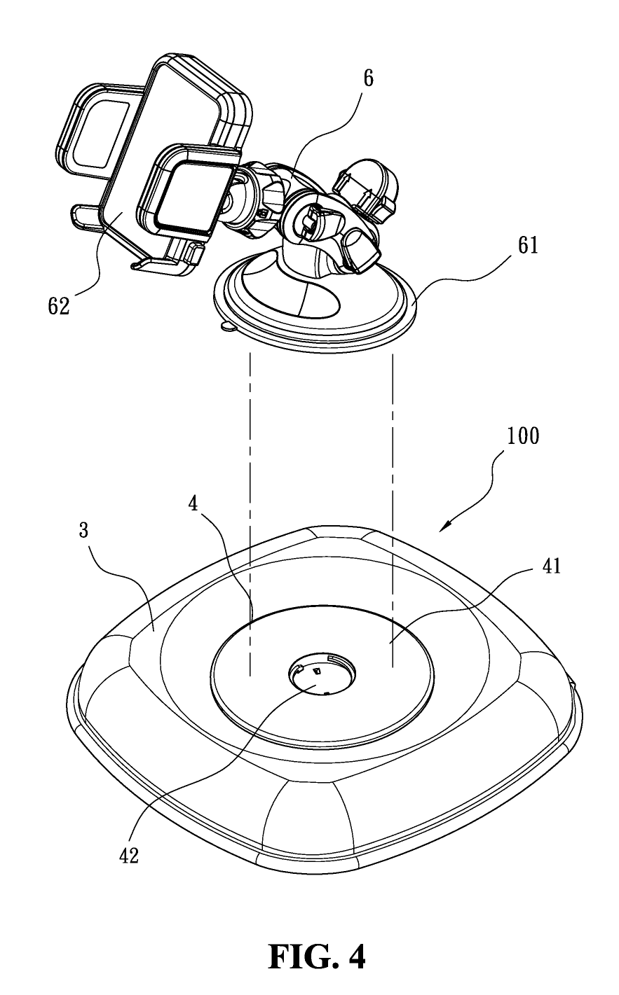

FIG. 4 shows a schematic view of the present invention in another actual application. A suction disc clapper set 6 is used to connect to the present invention. In this application, engaging trench 42 of connection unit 4 is not used. Suction disc clapper set 6 uses suction disc 61 to attach to suction area 41 of connection unit 4. The center region of suction disc 61 is above engaging trench 42. The remaining area of suction disc 61 is directly attached to the area surrounding engaging trench 42. When suction disc 61 is in use, there is no air leakage because engaging trench 42 is completely seal. Therefore, the concave sealed space of engaging trench 42 will not affect the suction effect between suction area 41 and suction disc 61. In this application, suction disc clapper set 6 also includes a clapper 62 for holding electronic apparatus.

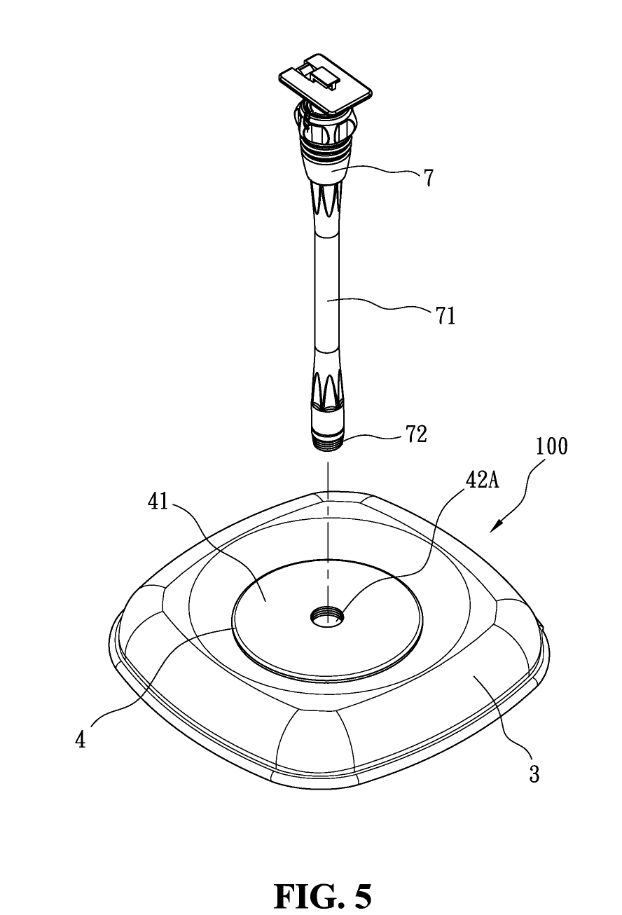

FIG. 5 shows a schematic view of the second embodiment of the present invention. In this embodiment, the difference is the shape of engaging trench 42A of connection unit 4. The inside of engaging trench 42A is like a screw nut. A support set 7 can be placed inside engaging trench 42A. Middle segment 71 of support set 7 is bendable, and a screw 72 is attached to the bottom of middle segment 71. By screwing screw 72 into screw nut of engaging trench 42A, support set 7 can be attached to connection unit 4 of connection base device 100.

In summary, the structure of engaging trench 42 of connection unit 4 is not limited to any specific shape, and can be designed to match the object to be connected. In addition, the engaging trench of the present invention is also not limited to the round shape, as in the embodiments.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A connection base device for connecting various objects, comprising:
at least a heavy unit;
a connection unit; and
a fix unit;
wherein said heavy unit further comprising a wrapping element, an anti-slip element and at least a heavy element, said wrapping element being upper part of said heavy unit and said anti-slip element being bottom part of said heavy unit, said heavy element being placed inside space formed between said anti-slip element and said wrapping element, said fix unit being engaged to bottom of said connection unit, and said fix unit and said connection unit clapping and holding a part of said heavy unit together;
top surface of said connection unit comprising a smooth suction area, center region of said suction area comprising an engaging trench, said engaging trench able to provide connection to said other various objects, wall and bottom of said engaging trench being completed sealed except opening to said suction area; and when said engaging trench not in use, suction disc able to attach to said suction area by suction effect.

2. The connection base device as claimed in claim 1, wherein said engaging trench has a structure matching the structure of said object to be connected to.

3. A connection base device for connecting to various objects, for providing installation connection to electronic apparatus using other said objects, said connection base device comprising a connection unit, wherein top surface of said connection unit comprising a smooth suction area, center region of said suction area comprising an engaging trench, said engaging trench able to provide connection to said other various objects, wall and bottom of said engaging trench being completed sealed except opening to said suction area; and when said engaging trench not in use, suction disc able to attach to said suction area by suction effect.
